(19) United States
(12) Patent Application Publication
(10) Pub. No.: US 2010/0309923 A1
(43) Pub. Date: Dec. 9, 2010

(54) GATEWAY INTEGRATING MOBILE COMMUNICATION AND POWERLINE CONNECTION

(76) Inventors: Hsu-Hui CHEN, Taipei Hsien (TW); Siang-Wei HUANG, Taipei Hsien (TW)

Correspondence Address: Hershkovitz & Associates, LLC, 2845 Duke Street, Alexandria, VA, 22314, US

(21) Appl. No.: 12/477,871

(22) Filed: Jun. 3, 2009

(51) Int. Cl. H04L 12/56; H04B 7/00

(52) U.S. Cl. 370/401; 370/310

(57) ABSTRACT

A gateway integrating mobile communication and powerline connection (PLC) has a network communication control unit, at least a wireline communication unit, a powerline communication unit and a mobile communication unit. The network communication control unit is connected with the wireline communication unit, the powerline communication unit and the mobile communication unit to convert, process and transmit network packets from the wireline communication unit, the powerline communication unit and the mobile communication unit. As such, the present invention is compatible with the network terminal using network cable, power line and mobile communication, thereby realizing the gateway integrating mobile communication and PLC.

### BACKGROUND OF THE INVENTION

1. Field of the Invention

The present invention relates to a gateway, and more particularly to a gateway integrating mobile communication and powerline connection (PLC).

2. Description of Related Art

With reference to FIG. 6, a conventional home network has a gateway (50) and a plurality of network terminals (70).

The gateway (50) has a plurality of network ports 51 and network cables (52). One end of each network cable (52) is plugged inside the corresponding network port (51). The end of the each network cable (52) is plugged inside the corresponding network terminal (70). The gateway (50) is further connected to the Public Switched Telephone Network (PSTN) (60) through an external trunk line (61). Therefore, the plurality of network terminals 70 are connected with the trunk line (61) through the gateway (50).

The aforementioned gateway (50) stores unique network addresses of the network terminals which are registered successfully in the gateway (50) so as to successfully forward the network packets transmitted from the trunk line (61) to the specific network terminal (70) according to the network packets. Likewise, the network terminals (70) also transmits their network packets to the trunk line (61) through the gateway (50) and further to one network device (not shown) linking to the Internet via the trunk line (61). Such home network is the most common and prevailing one. As the initial networks evolve from the concept of wireline network to the mature wireless technology today, wireless communication becomes no longer an idea but an integration solution or a substitute to the wireline network.

With reference to FIG. 7, a wireless home network is roughly the same as that of the aforementioned home network. The wireless home network uses a wireless gateway (50a) having an antenna (53) as an access point (AP), and each network terminal (70) is further connected to a transceiver (71) linking to the gateway (50a) through the antenna (53). Therefore, the wireless home network does not require the network cables so a complicated network cable distribution process can be waived accordingly. However, the cable distribution to the trunk line 61 is still unavoidable. Since the above-mentioned wireless home network is implemented at home, the distances between the wireless gateway and the plural network terminals 70 are in the short range, a communication quality of the wireless home network is good. Although a home environment makes the realization of wireless network architecture easier, the wireless signal which follows the currently common wireless network protocols IEEE 802.11a/b/g using the frequency band 2.4 GHz is prone to the interference from the UHF wave emitted by a household microwave oven. Consequently, the performance of connection while adopting the wireless gateway (50a) is not as good as that of wireline connection.

With reference to FIG. 8, a latest gateway (50b) integrating the function of the third-generation (3G) mobile network has a processor (501), a local area network (LAN) chip (502) and a 3G mobile communication unit (503).

The processor 501 is used to process and transmitting packet data. The local area network (LAN) chip (502) is connected to the processor (501) to receive packet data from the processor (501), convert the packet data into network packets and then transmit the network packets to the network terminals (70) via the network cable (52), and forwards packet data transmitted via the network cables (52) to the processor (501); and

a 3G mobile communication unit (503) is connected to the processor (501) and containing an antenna (504) for receiving packet data from the processor (501), converting the packet data to wireless signals to transmit the wireless signals to the mobile base station (80), and transmitting packet data received from the mobile base station (80) to the processor (501).

The aforementioned gateway (50b) mainly resolves the cable distribution issue from the trunk line to home. Because the transmission of digital packets is supported by the protocols of the 3G mobile communication since its very beginning, mobile network is apparently an increasingly mature solution nowadays. Furthermore, the base station (80) has higher deployment density and faster and better connection quality than those of the wireless local area network (WLAN). As a result, wireless communication is indeed a solution to the cable distribution from trunk line to home. Whereas, although the gateway (50b) requires no complicated cable distribution for, e.g. ADSL trunk line, the connection means to a plurality of network terminals 71 at home still relies on the distribution of the existing network cables (52) which impossibly provides an easiest home network architecture to be built.

To overcome the shortcomings, the present invention provides a gateway integrating mobile communication and PLC to mitigate or obviate the aforementioned problems.

### SUMMARY OF THE INVENTION

The main objective of the present invention is to provide a gateway integrating mobile communication and PLC, not only promoting the application of the gateway but also facilitating to speed up the implementation of a home network.

The gateway integrating mobile communication and PLC has:

a wireline communication unit connected with an external LAN or at least a network terminal with at least a network cable to transmit at least a network packet;

a powerline communication unit connected with a powerline network or at least a network terminal with at least a power line to transmit at least a network packet;

a mobile communication unit transmitting at least a wireless network packet to a mobile base station through an antenna; and

a network communication control unit connected with the wireline communication unit, the powerline communication unit and the mobile communication unit to convert, process and transmit at least a network packet from the wireline communication unit, the powerline communication unit and the mobile communication unit.

It is known from the contents mentioned above that the present invention employs the network communication control unit to integrate the wireline communication unit, the powerline communication unit and the mobile communication unit as a bridging unit of those communication units. As such, in addition to using original network cables in connection with external network terminals, the gateway of the present invention further provides user a means to connect with an external network terminal through power line, thereby eliminating complicated cable distribution. Moreover, the gateway of the present invention can also selectively connect to an external mobile network, allowing a plurality of network terminals at home to conveniently and swiftly establish a home network and to connect to the Internet by virtue of the present invention.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of a gateway in accordance with the present invention;

FIG. 2 is a functional block diagram of the first preferred embodiment of the gateway, which is connected to a plurality of the network terminals;

FIG. 3 is a perspective view of a second preferred embodiment of a gateway in accordance with the present invention;

FIG. 4 is a functional block diagram of the second preferred embodiment of the gateway in accordance with the present invention;

FIG. 5 is another functional block diagram of the first preferred embodiment, which is connected to the plurality of the network terminals and a mobile base station;

FIG. 6 is a block diagram of a conventional home network in accordance with the prior art;

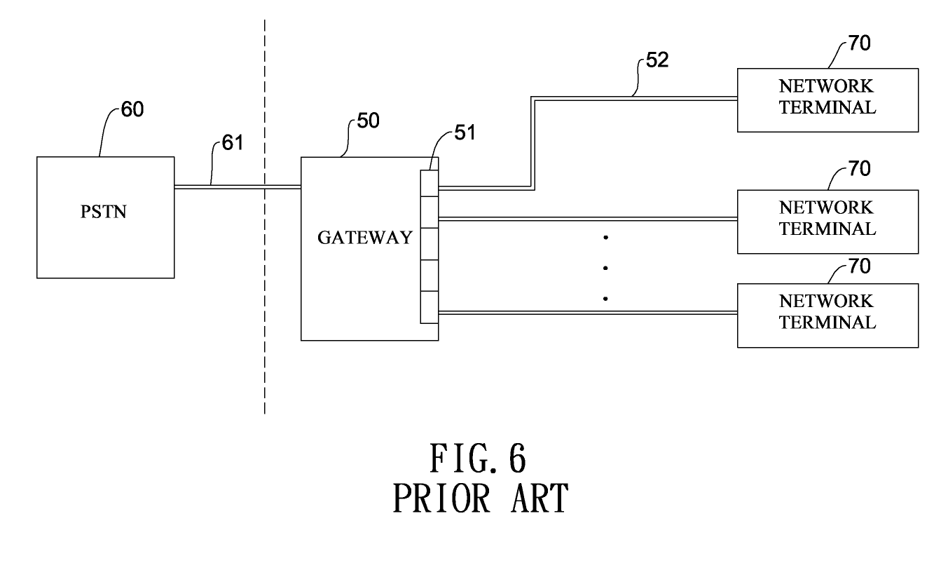

FIG. 7 is a block diagram of a conventional wireless home network; and

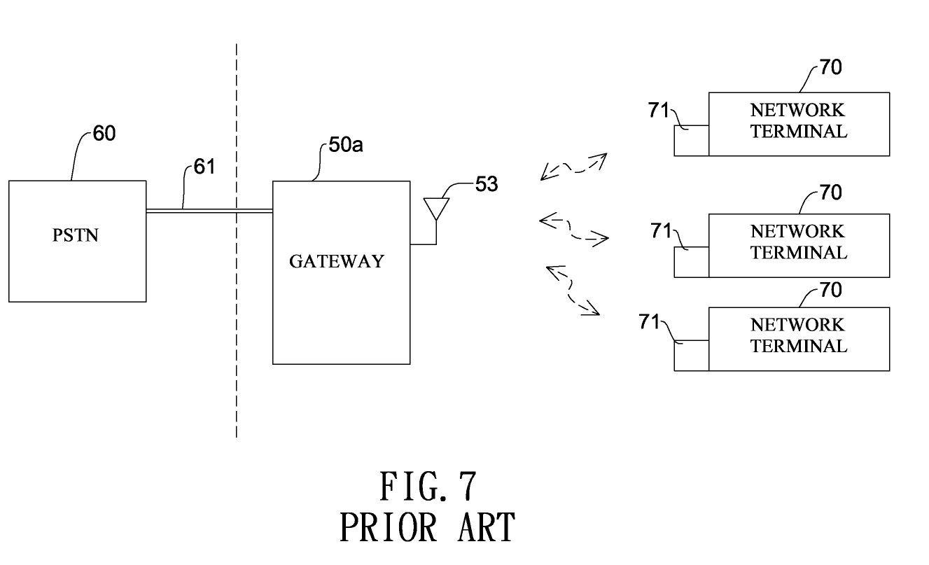

FIG. 8 is a functional block diagram of a conventional gateway having a 3 G communication module.

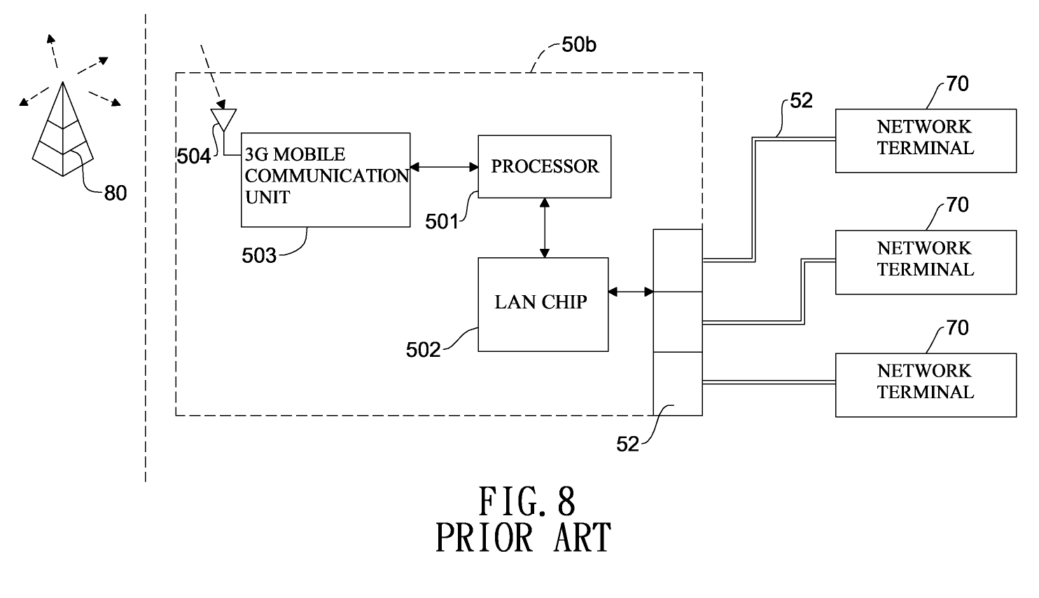

### DETAILED DESCRIPTION OF THE PREFERRED EMBODIMENT

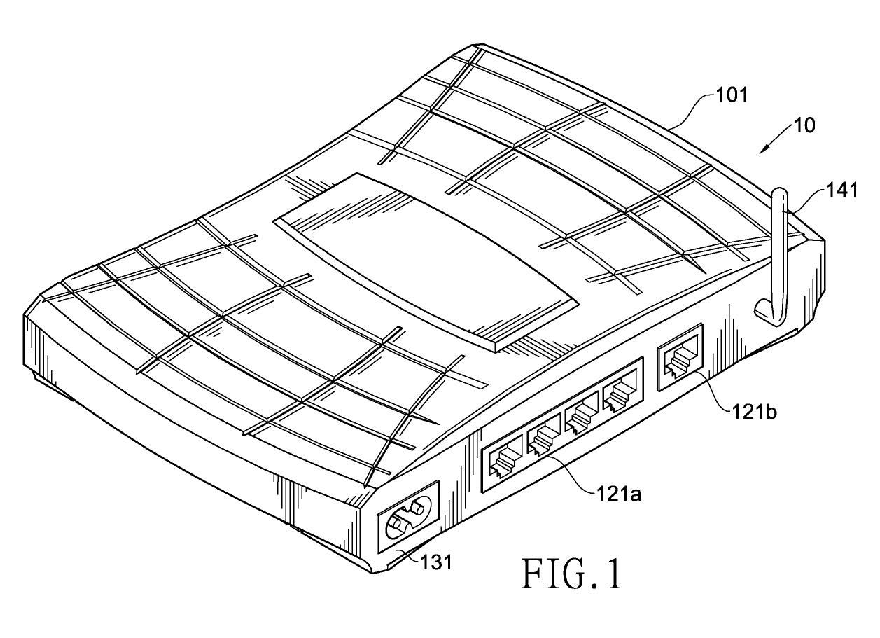

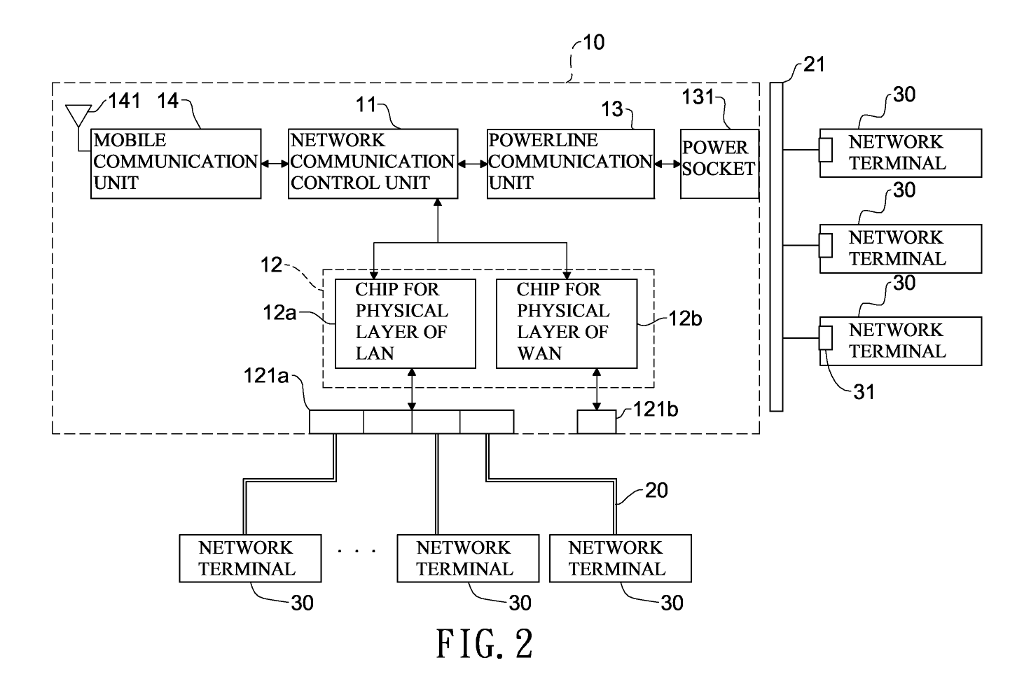

With reference to FIGS. 1 and 2, a first preferred embodiment of a gateway in accordance with the present invention has a casing (101), a wireline communication unit (12), a powerline communication unit (13), a mobile communication unit (14) and a network communication control unit 11.

The casing has a plurality of network ports (121a, 121b) and a power socket (131) which are mounted on one side of the casing (101).

The wireline communication unit (12) is connected to an external LAN or the network terminals (30) via the network cable (20) for the transmission of network packets. The wireline communication unit (12) has a chip for physical layer of LAN (12a) and a chip for physical layer of WAN (wide area network) (12b), in which the chip for physical layer of LAN (12a) is connected with the plural RJ45 network ports (121a) to connect with the plural network terminals (30) via the network cables (20), and the chip for physical layer of WAN (12b) is connected with a RJ45 network port (121b) to connect to an external WAN via the network cable (20).

The powerline communication unit (13) is connected with a powerline network or a plurality of network terminals (30) through a power line (21) for the transmission of network packets. The powerline communication unit (13) is connected with the power socket (131) on the casing (101) for the power line (21) to be plugged therein.

The mobile communication unit (14) links to a mobile base station and transmits and receives wireless network packets to and from the mobile base station. The mobile communication unit (14) can be a 3G, 3.5G or 4G mobile communication unit.

The network communication control unit (11) is connected with the wireline communication unit (12), the powerline communication unit (13) and the mobile communication unit (14) to convert, process and transmit network packets from the wireline communication unit (12), the powerline communication unit (13) and the mobile communication unit (14).

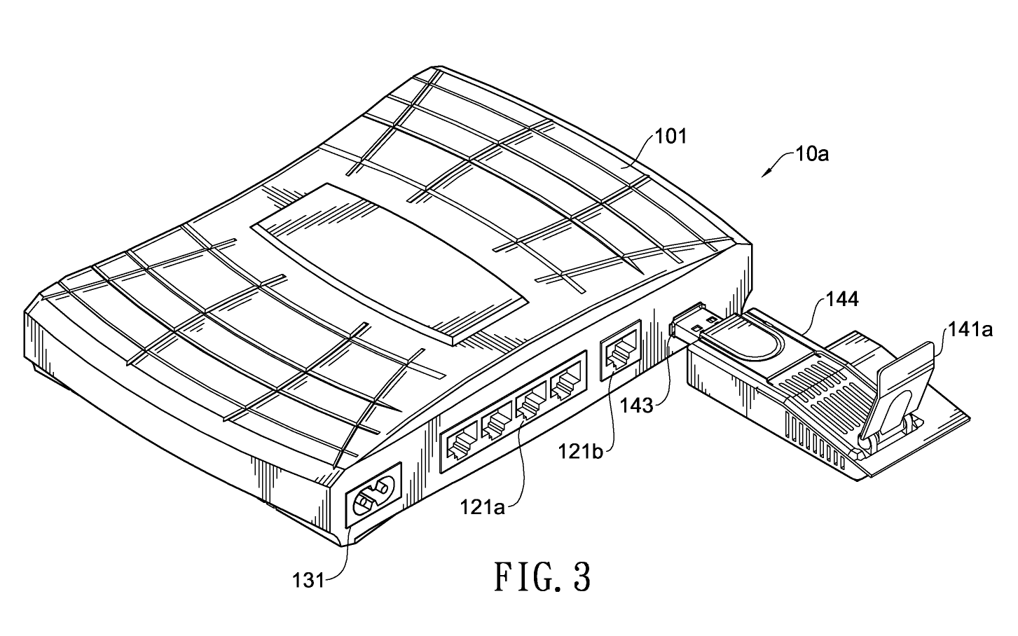

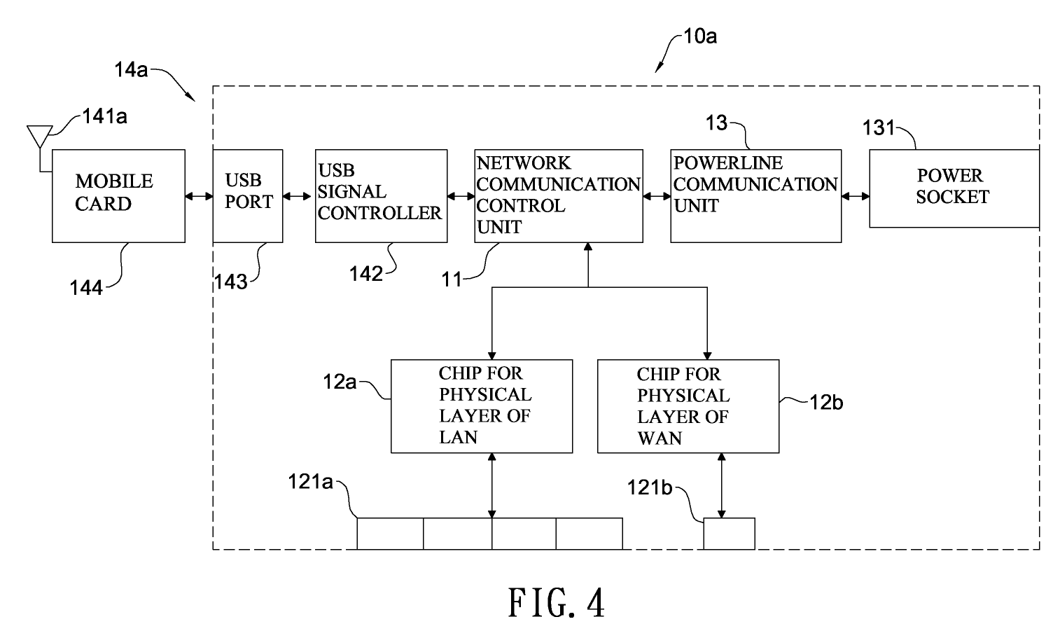

With reference to FIG. 3 and FIG. 4, a second preferred embodiment of a gateway (10a) in accordance with the present invention mostly resembles with the first preferred embodiment in terms of their architectures while the mobile communication unit (14a) of the second preferred embodiment further has a USB signal controller (142), a USB port (143), and a mobile card (144).

The USB signal controller (142) is mounted inside the casing (101) and is connected with the network communication control unit (11).

The USB port (143) is mounted on one side of the casing (101) and is connected with the USB signal controller (142).

The mobile card (144) is plugged in the USB port (143) on the casing (101), connected with the USB signal controller (142) through the USB port (143), and connected to the mobile base station via an antenna (141a).

In the second embodiment after the mobile card (144) is plugged in the USB port (143), the network communication control unit (11) automatically reads a preset mobile phone number and dials through the mobile card (144) to connect to a neighboring mobile base station. Once the connection session is over, the network packets of the wireless signals received by the mobile base station are fetched and converted in form of a USB signal format and are transmitted to the USB signal controller (142) through the USB port (143). After the USB signal controller (142) is converted to have an input interface protocol in compliance with that of the network communication control unit (11), the network communication control unit (11) can receive the network packets transmitted from the mobile base station. On the contrary, when the network communication control unit (11) converts the network packets from the wireline communication unit (12) or the powerline communication unit (13), the network packets are converted by the USB signal controller (142) and then transmitted to the mobile card (144) through the USB port (143). As the mobile network is connected with the mobile base station, the network packets can be successfully transmitted to the mobile base station and further into the mobile network accordingly.

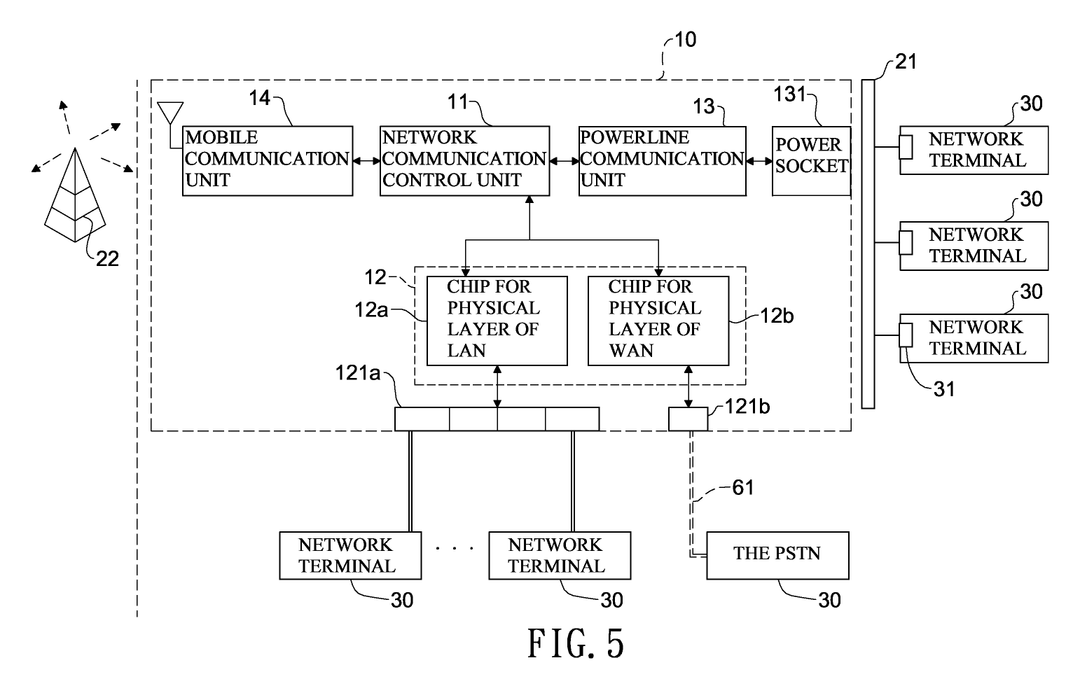

With reference to FIG. 5, the first preferred embodiment of the gateway (10) is adopted in a home network. Therefore, the home network has a plurality of network terminals (30), a plurality of powerline modems (31), and a gateway (10).

Each powerline modem is plugged in a respective power receptacle at home and connected with a corresponding network terminal 30.

The gateway (10) is plugged in a power receptacle at home and the power socket (131) on the casing (101) with a power line (21) so that the powerline communication unit (13) is coupled to the power line 21.

In view of the high deployment density of the mobile base station (22) together with the mature development of the 3G, 3.5G and 4G mobile technologies, the mobile communication unit (14) of the gateway (10) in accordance with the present invention can establish connection with good quality to the mobile base station (22) at any time. Hence, once the gateway (10) of the present invention is connected with the mobile base station (22), a home network can be constructed by virtue of the gateway (10) of the present invention and the physical network formed by household power lines (21) as long as the power lines (21) distributed at home are utilized well and buried fully. In collaboration with the use of the mobile communication module (14), each user of the network terminal (30) at home can swiftly surf on the Internet. Moreover, the gateway (10) includes a chip for physical layer of WAN (12b) and a chip for physical layer of LAN (12a). To a family having the ADSL trunk line (61) of the PSTN (60), the ADSL trunk line (61) is plugged in the RJ45 network port (121b) tailored to the chip for physical layer of WAN, and part of the network terminals (20) are plugged in the RJ45 network ports (121a) of the chip for physical layer of LAN, thereby allowing user to select the path in connection with the Internet with the ADSL trunk line (61).

It is obvious from the foregoing description that using the gateway of the present invention to construct a home network is relatively fast without having to hook up network terminal and the gateway with network cable, and the direct use of domestic power line gets rid of the complicated cable distribution process. Besides, as a result of the established deployment of mobile network, large bandwidth and fast speed so far, it is possible to connect to the Internet without requiring the last-mile solution, e.g. ADSL trunk line, electrical cable or fiber, to home. As such, the gateway of the present invention not only eliminates the internal cable distribution at home but also removes the cable distribution of external circuitry to home, thereby truly facilitating to enhance the convenience in establishing a home network.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A gateway integrating mobile communication and powerline connection (PLC), comprising:
a wireline communication unit adapted to connect with an external LAN or at least a first network terminal with at least a network cable to transmit network packets;
a powerline communication unit adapted to connect with a powerline network or at least a second network terminal with at least a power line to transmit network packets;
a mobile communication unit adapted to link a mobile base station through an antenna to transmit wireless network packets to the mobile base station; and
a network communication control unit connected with the wireline communication unit, the powerline communication unit and the mobile communication unit to convert, process and transmit at least a network packet from the wireline communication unit, the powerline communication unit and the mobile communication unit.

2. The gateway integrating mobile communication and PLC as claimed in claim 1, wherein the mobile communication unit further comprises:
a USB signal controller connected with the network communication control unit;
a USB port connected with the USB signal controller; and
a mobile card plugged in the USB port, connected with the USB signal controller through the USB port, and connected to the mobile base station through an antenna.

3. The gateway integrating mobile communication and PLC as claimed in claim 1, wherein the mobile communication unit is one of 3G, 3.5G and 4G mobile communication units.

4. The gateway integrating mobile communication and PLC as claimed in claim 2, wherein the mobile communication unit is one of 3G, 3.5G and 4G mobile communication units.

5. The gateway integrating mobile communication and PLC as claimed in claim 1, wherein the powerline communication unit comprises a power socket.

6. The gateway integrating mobile communication and PLC as claimed in claim 2, wherein the powerline communication unit comprises a power socket.

7. The gateway integrating mobile communication and PLC as claimed in claim 3, wherein the powerline communication unit comprises a power socket.

8. The gateway integrating mobile communication and PLC as claimed in claim 1, wherein the wireline communication unit comprises a chip for physical layer of LAN and is connected with a plurality of RJ45 network ports.

9. The gateway integrating mobile communication and PLC as claimed in claim 2, wherein the wireline communication unit comprises a chip for physical layer of LAN and is connected with a plurality of RJ45 network ports.

10. The gateway integrating mobile communication and PLC as claimed in claim 8, wherein the wireline communication unit comprises a chip for physical layer of WAN and is connected with a RJ45 network port.

11. The gateway integrating mobile communication and PLC as claimed in claim 9, wherein the wireline communication unit comprises a chip for physical layer of WAN and is connected with a RJ45 network port.
